(19) United States
(12) Patent Application Publication
(10) Pub. No.: US 2010/0044166 A1
(43) Pub. Date: Feb. 25, 2010

(54) SELF-BOOSTING DISK BRAKE

(76) Inventor: Dietmar Baumann, Hemmingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/444,498

(22) PCT Filed: Sep. 10, 2007
(86) PCT No.: PCT/EP2007/059444

§ 371 Date: Apr. 6, 2009

(30) Foreign Application Priority Data
Oct. 6, 2006 (DE) 10 2006 047 408.2

(51) Int. Cl. F16D 55/46; F16D 65/14

(52) U.S. Cl. 188/72.2

(57) ABSTRACT

The invention relates to a self-boosting disk brake having a friction brake lining with a wedge on its rear side that faces away from the brake disk. The wedge supports the friction brake lining in a brake caliper when the disk brake is actuated. The wedge principle achieves self-boosting of the disk brake. The invention proposes providing a wedge-shaped support element between the wedge and a brake caliper, the support element supporting the wedge of the friction brake lining on the brake caliper. In order to actuate the disk brake, the support element is moved by an actuating device against the wedge.

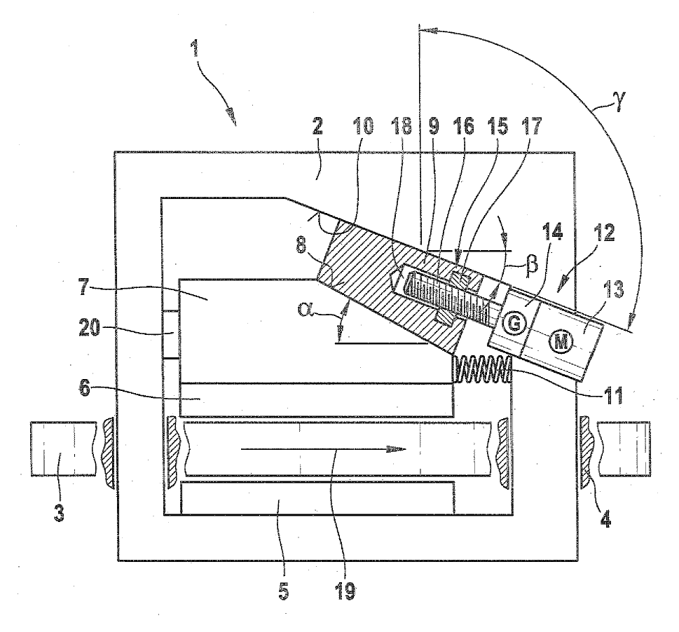

### PRIOR ART

The invention relates to a self-boosting disk brake having the characteristics of the preamble to claim 1.

One such disk brake that has self-boosting is known from International Patent Disclosure WO 98/14715. The known disk brake has a friction brake lining that is disposed on one side of a brake disk and that for actuation of the disk brake can be pressed by an actuating device against the brake disk. To attain the self-boosting, the friction brake lining has a wedge on its back side, facing away from the brake disk, and the friction brake lining together with the wedge can be displaced in a circumferential direction of the brake disk. The actuating device acts perpendicular to the wedge and thus at a wedge angle to a perpendicular to the brake disk.

If, for actuating the disk brake, the friction brake lining is pressed by the actuating device against the rotating brake disk, then the rotating brake disk exerts a frictional force in the rotational and circumferential direction on the friction brake lining with the wedge, which is displaced with the friction brake lining in the direction of rotation of the brake disk. The displacement of the wedge brings about a positioning of the friction brake lining perpendicular to the brake disk; that is, a portion of the positioning travel necessary for actuating the disk brake is due to the displacement of the wedge. The disk brake is travel-boosting or travel-increasing; the positioning travel of the friction brake lining perpendicular to the brake disk is greater than the actuation travel of the actuating device.

### SUMMARY OF THE INVENTION

The disk brake of the invention having the characteristics of claim 1 has a wedgelike bracing element, which is disposed between the wedge, on the back side of the friction brake lining facing away from the brake disk, and an abutment. The abutment is in particular a component of a brake caliper or is disposed in a brake caliper. By way of the wedgelike bracing element, the wedge of the friction brake lining and thus the friction brake lining itself as well are displaced on the abutment. The wedgelike bracing element tapers in the opposite direction from the wedge of the friction brake lining, and the wedgelike bracing element is displaceable in the opposite direction from the friction brake lining with the wedge. The actuating device of the disk brake of the invention does not act directly on the friction brake lining or its wedge; instead, it displaces the wedgelike bracing element. For actuating the disk brake of the invention, the wedgelike bracing element is displaced with the actuating device into an increasingly narrower wedge gap between the abutment and the wedge of the friction brake lining. In that process, the wedgelike bracing element presses the wedge with the friction brake lining away from the abutment and against the brake disk, which as a result is braked.

The disk brake of the invention has travel boosting. In addition to the travel boosting, the disk brake of the invention has a force boost. The term boosting is understood to mean utilizing auxiliary energy for actuating the disk brake. With the invention, kinetic energy of a vehicle equipped with the disk brake, that is, of the rotating brake disk that is braked with the disk brake, is used as auxiliary energy for brake actuation. The actuation energy and actuation power to be exerted by the actuating device of the disk brake are reduced by the utilization of auxiliary energy. Unlike that situation, the term force boost should be understood to mean an increase in a force without auxiliary energy. The force and travel vary in opposite directions; the actuation energy and actuation power remain unchanged. The tensing force, that is, the contact pressure of the friction brake lining against the brake disk, is increased; the actuation force exerted by the actuating device on the wedgelike bracing element is less than the tensing force. Instead, the actuation travel increases, that is, the displacement travel of the wedgelike bracing element in proportion to the positioning travel of the friction brake lining to the brake disk.

The travel boosting of the disk brake of the invention is obtained because, with the disk brake actuated, the rotating brake disk urges the friction brake lining, pressed against it, with its wedge in the circumferential direction and rotational direction. As a result, the rotating brake disk displaces the friction brake lining with the wedge counter to the wedgelike bracing element. The displacement of the wedge of the friction brake lining on the wedgelike bracing element causes a positioning motion of the wedge with the friction brake lining toward the brake disk. This means that some of the positioning travel of the friction brake lining to the brake disk is generated by the displacement of the friction brake lining with the wedge in the direction of rotation of the brake disk. The positioning travel to be effected by the actuating device is shortened accordingly. The travel boosting of the disk brake of the invention reduces the amount of actuation energy required and makes it possible to use a less-powerful and thus lighter-weight and smaller actuating device. With the travel boosting, the disk brake of the invention has self-boosting. Unlike the situation in the previously known disk brake in WO 98/14715 mentioned at the outset, the friction brake lining of the disk brake of the invention is not, or at least not exclusively, braced on the actuating device but rather on the abutment via the wedgelike bracing element. This has the advantage that a bracing force required for exerting pressure on the friction brake lining need not be exerted by the actuating device, or needs to be exerted only to a reduced extent. The actuating device is relieved. The force boost is attained by means of the wedgelike bracing element.

The motion of the friction brake lining in the circumferential direction of the brake disk and along the wedge face of the wedgelike bracing element is a motion along an imaginary helical line whose axis coincides with the axis of rotation of the brake disk. The displacement of the friction brake lining is as a rule only a small fraction of one complete revolution. The slope of the imaginary helical line along which the friction brake lining is displaceable need not necessarily be constant; instead, it may vary over the displacement travel of the friction lining. The displacement direction of the friction brake lining may deviate from the circumferential direction of the brake disk; what is necessary is that a component of the displacement point in the circumferential direction of the brake disk, in order to bring about the described self-boosting. The friction brake lining can for instance also extend along an imaginary straight line in the direction of a chord to the brake disk. The characteristics called wedge and wedge shape should also be understood in the sense of the invention to mean that the friction brake lining is displaceable at an angle to the brake disk.

The dependent claims have advantageous features and refinements of the invention defined by claim 1 as their subjects.

Claim 2 contemplates a spring element which urges the friction brake lining and the wedge in the direction in which the wedge widens, that is, the direction of displacement of the wedgelike bracing element upon actuation of the disk brake, and counter to the displacement of the friction brake lining in the direction of rotation of the brake disk. The spring element limits the displacement of the friction brake lining and its wedge when the disk brake has been actuated. The spring element avoids self-locking of the disk brake and blocking of the brake disk when the self-boosting is high, since the braking force does not increase arbitrarily as a result of the frictional force exerted by the rotating brake disk on the friction brake lining that presses against it when the disk brake is actuated; instead, the displacement of the friction brake lining and hence the braking force of the spring element are limited. As a result, high self-boosting of the disk brake of the invention is possible, and this is the subject of claim 3. High self-boosting makes a less-powerful actuating device possible. Claim 3 is worded such that the tangent of a wedge angle of the wedge of the friction brake lining is less than a coefficient of friction between the friction brake lining and the brake disk. This condition intrinsically means operation of the disk brake in the self-locking range, and as noted, the self-locking is avoided by means of the spring element. Claim 3 should be understood to mean that in any case, when the coefficient of friction is high, the disk brake can reach the range of self-locking. The coefficient of friction varies with the operating condition, such as wet weather, soiling, and temperature in particular.

The abutment may extend parallel to the brake disk. Claim 4 contemplates that the abutment extends at an angle of inclination obliquely to the brake disk. As a result, not only the travel boosting but also force boost are attained. The angle of inclination is in the same direction as the wedge angle of the wedge of the friction brake lining; that is, the abutment extends in the same direction obliquely to the brake disk as a wedge face of the wedge. However, the angle of inclination is less than the wedge angle, if the abutment does not extend parallel to the brake disk. In addition to the angle of inclination, a support angle between the abutment and a normal to the brake disk should also be taken into account.

In particular, the disk brake of the invention is contemplated for electromechanical actuation; according to claim 5, it has an electromechanical actuating device. What is typical is an electric motor, which often displaces the bracing element via a step-down gear and a rotation-to-translation conversion gear. The rotation-to-translation conversion gear may be a screw thread drive or for instance a rack gear. A conversion of the rotary motion of the electric motor into a translational motion for displacing the bracing element, for instance by means of a cam or a crank with a connecting rod, is also possible. A linear drive, for instance with a linear motor, an electromagnet, or a piezoelectric element, is also possible.

### BRIEF DESCRIPTION OF THE DRAWING

The invention will be described in further detail below in terms of an embodiment shown in the drawing. The sole FIGURE of the drawing shows a disk brake of the invention, looking radially from outside toward a brake disk. The drawing should be understood to be a schematic, simplified illustration for the sake of comprehension and explanation of the invention.

### EMBODIMENT OF THE INVENTION

The disk brake 1 of the invention shown in the drawing has a brake caliper 2, which as a so-called floating caliper is displaceable transversely to a brake disk 3. Sliding guides 4 of the brake caliper 2 are represented symbolically in the drawing.

On one side of the brake disk 3, a friction brake lining 5 is disposed immovably in the brake caliper 2. This friction brake lining 5 will hereinafter also be called a fixed friction brake lining 5. On the other side of the brake disk 3, a friction brake lining 6 is disposed movably in the brake caliper 2 and for actuation of the disk brake 1 can be pressed against the brake disk 3. On a back side, facing away from the brake disk 3, the movable friction brake lining 6 has a wedge 7 with a wedge face 8 that extends at a wedge angle α to the brake disk 3. With the wedge face 8, the movable friction brake lining 6 is braced via its wedge 7 on a wedgelike bracing element 9, which in turn is braced on an abutment 10 of the brake caliper 2. The abutment 10, in the embodiment of the invention described and shown, is an oblique face, which extends at an angle of inclination β to the brake disk 3. It is also possible for the abutment 10 to extend parallel to the brake disk 3 (not shown). The difference between the angle of inclination β of the abutment 10 and the wedge angle α of the wedge 7 is equivalent to a wedge angle of the wedgelike bracing element 9. The oblique faces of the wedge 7 of the friction brake lining 6 and of the wedgelike bracing element 9 are oriented in opposite directions from one another; that is, the wedgelike bracing element 9 tapers in the opposite direction from the wedge 7. Besides the angle of inclination γ, the support angle β between the abutment 10 and a normal to the brake disk 3 should also be taken into account.

The wedge 7 with the friction brake lining 6 is displaceable in the circumferential direction of the brake disk 3. In the process, its wedge face 8 slides on the bracing element 9; that is, the wedge 7 with the friction brake lining 6 moves by the wedge angle α relative to the brake disk 3. The motion of the wedge 7 with the friction brake lining 6 is a displacement along an imaginary, helical path whose axis coincides with the axis of rotation of the brake disk 3. In the circumferential direction, the displacement of the wedge 7 with the friction brake lining 6 is limited to a small fraction of one complete revolution.

A spring element 11, represented in the drawing with the symbol for a helical compression spring, engages the movable friction brake lining 6 or its wedge 7 and is braced on the brake caliper 2. The spring element 11 acts in the circumferential direction of the brake disk 6, or in other words in the direction of displacement of the wedge 7 and friction brake lining 6.

For its actuation, the disk brake 1 of the invention has an electromechanical actuating device 12, but in principle any other actuating device, for instance hydraulic or pneumatic, is also possible. The actuating device 12 has an electric motor 13, which displaces the bracing element 9 via a flanged-on step-down gear 14 and a screw thread drive 15. In the embodiment of the invention shown and described, a spindle drive with a spindle 16 and a nut 17 is used as the screw thread drive 15. The nut 17 is located, fixed against relative rotation and axially, in a bore 18 of the bracing element 9. A direction of action of the actuating device 12 extends at an angle between the wedge face 8 and the abutment 10; limit cases in terms of the direction of action of the actuating device 12 are parallel to the wedge face 8 or parallel to the abutment 10; that is, by the wedge angle α or the angle of inclination β to the brake disk 3. This angular limitation to the direction of action of the actuating device 12 is not compulsory; if lesser efficiency is acceptable, the direction of action of the actuating device 12 may also be located outside the angles given. What is necessary is the displaceability of the bracing element 9 in the circumferential direction of the brake disk 3.

For actuation of the disk brake 1, the wedgelike bracing element 9 is displaced by the electromechanical actuating device 12 along the abutment 10 of the brake caliper 2, or in other words in the circumferential direction of the brake disk 3 and by the angle of inclination β to the brake disk 3. The bracing element 9 is displaced into an increasingly narrow wedge gap between the abutment 10 and the wedge face 8 of the wedge 7 of the friction brake lining 6, or in other words counter to the wedge 7 and away from the brake disk 3 by the angle of inclination β. Because of its widening wedge shape, the bracing element 9 presses the wedge 7 away from the abutment 10 and consequently presses the movable friction brake lining 6 against the brake disk 3. As a result of the pressing of the movable friction brake lining 6 against one side of the brake disk 3, the brake caliper 2, which as a floating caliper is displaceable transversely to the brake disk 3, is displaced transversely to the brake disk 3 and presses the fixed friction brake lining 5 against the other side of the brake disk 3, which is braked with both friction brake linings 5, 6.

In the direction of rotation, represented by arrow 19, of the brake disk 3, the rotating brake disk 3 exerts a frictional force in its circumferential and rotational direction on the friction brake linings 5, 6. The frictional force urges the movable friction brake lining 6 and its wedge 7 in the direction of an increasingly narrow wedge gap between the brake disk 3 and the bracing element 9. The frictional force exerted by the brake disk 3 on the friction brake lining 6 pressed against it displaces the friction brake lining 6, together with its wedge 7, counter to the displacement of the bracing element 9 by the actuating device 12. The friction brake lining 6 is displaced toward the brake disk 3 by the wedge angle α; that is, part of a positioning travel of the friction brake lining 6 to the brake disk 3 results from the frictional force exerted by the rotating brake disk 3 on the friction brake lining 6 pressed against it. Travel boosting thus ensues; the actuating device 12 produces only a portion of the positioning travel required for actuating the disk brake 1, and another portion is produced, as described, by the rotating brake disk 3.

In addition, a force boost is effected as a result of the bracing of the bracing element 9 by the angle of inclination β on the abutment 10 of the brake caliper 2. The frictional force exerted by the rotating brake disk 3 on the friction brake lining 6 pressed against it when the disk brake 1 is actuated effects bracing on the abutment 10 with a bracing force perpendicular to the abutment 10. This bracing force has a force component perpendicular to the brake disk 3, which presses the friction brake lining 6 against the brake disk 3. The contact pressure, produced by the actuating device 12, of the friction brake lining 6 against the brake disk 3 and thus a braking force of the disk brake 1 are increased as a result. The disk brake 1 of the invention has self-boosting; it is travel-boosting and force-boosting.

Upon displacement of the friction brake lining 6 together with its wedge 7 in the direction of rotation of the brake disk 3, the wedge 7 tenses the spring element 11, which exerts a spring force on the wedge 7 counter to the displacement direction. The spring force increases with increasing displacement of the wedge 7 and the attendant increasing tension of the spring element 11. The spring force of the spring element 11 increases until such time as a force equilibrium prevails. The displacement of the friction brake lining 6 is limited by the spring element 11; even in major self-boosting or even self-boosting tending toward infinity, the braking force of the disk brake 1 does not increase arbitrarily but only increases up to a value defined by the tension of the spring element 11. The disk brake 1 of the invention therefore makes high self-boosting possible without the risk of self-locking. This means that the disk brake 1 of the invention does not unintentionally block the brake disk 3 as a result of the displacement of the friction brake lining 6 in response to the frictional force exerted on it by the brake disk 3. This must be distinguished from blocking of the brake disk 3 as a result of the braking force of the disk brake 1 that is exerted by the actuating device 12 and is boosted by the self-boosting. The braking force of the disk brake 1, despite the spring element 11, is dependent on the actuation force produced by the actuating device 12.

A stop 20 of the brake caliper 2 limits a displacement travel of the movable friction brake lining 6 and its wedge 7 in the releasing direction of the disk brake 1.

Wear compensation is possible in a simple way because the bracing element 9 upon release of the disk brake 1 is not displaced back into its outset position but instead only far enough that a desired air gap is established between the friction brake linings 5, 6 and the brake disk 3.

1-5. (canceled)

6. A self-boosting disk brake, comprising:
a brake disk;
a friction brake lining;
an actuating device for actuating the disk brake, with which the friction brake lining can be pressed against the brake disk, and with which the friction brake lining is displaceable in a circumferential direction to the brake disk;
a wedge on a back side of the friction brake lining facing away from the brake disk, the wedge tapering in the circumferential direction to the brake disk in which the friction brake lining is displaceable;
a wedge-like bracing element which tapers in an opposite direction from the wedge of the friction brake lining, the wedge-like bracing element being displaceable in the opposite direction from the friction brake lining with the wedge, and via the wedge-like bracing element the wedge of the friction brake lining is braced on an abutment, wherein for actuating the disk brake, the bracing element is displaceable with the actuating device.

7. The self-boosting disk brake as defined by claim 6, wherein the disk brake has a spring element, which urges the friction brake lining with the wedge in the direction in which the wedge widens.

8. The self-boosting disk brake as defined by claim 6, wherein a tangent of a wedge angle of the wedge of the friction brake lining is less than a coefficient of friction between the friction brake lining and the brake disk.

9. The self-boosting disk brake as defined by claim 7, wherein a tangent of a wedge angle of the wedge of the friction brake lining is less than a coefficient of friction between the friction brake lining and the brake disk.

10. The self-boosting disk brake as defined by claim 6, wherein the abutment extends at an angle of inclination to the brake disk; and that the angle of inclination of the abutment to the brake disk is oriented in a same direction as a wedge angle of the wedge of the friction brake lining.

11. The self-boosting disk brake as defined by claim 7, wherein the abutment extends at an angle of inclination to the brake disk; and that the angle of inclination of the abutment to the brake disk is oriented in a same direction as a wedge angle of the wedge of the friction brake lining.

12. The self-boosting disk brake as defined by claim 8, wherein the abutment extends at an angle of inclination to the brake disk; and that the angle of inclination of the abutment to the brake disk is oriented in a same direction as a wedge angle of the wedge of the friction brake lining.

13. The self-boosting disk brake as defined by claim 9, wherein the abutment extends at an angle of inclination to the brake disk; and that the angle of inclination of the abutment to the brake disk is oriented in a same direction as a wedge angle of the wedge of the friction brake lining.

14. The self-boosting disk brake as defined by claim 6, wherein the disk brake has an electromechanical actuating device.

15. The self-boosting disk brake as defined by claim 7, wherein the disk brake has an electromechanical actuating device.

16. The self-boosting disk brake as defined by claim 8, wherein the disk brake has an electromechanical actuating device.

17. The self-boosting disk brake as defined by claim 9, wherein the disk brake has an electromechanical actuating device.

18. The self-boosting disk brake as defined by claim 10, wherein the disk brake has an electromechanical actuating device.

19. The self-boosting disk brake as defined by claim 11, wherein the disk brake has an electromechanical actuating device.

20. The self-boosting disk brake as defined by claim 12, wherein the disk brake has an electromechanical actuating device.

21. The self-boosting disk brake as defined by claim 13, wherein the disk brake has an electromechanical actuating device.
